(19) United States
(12) Patent Application Publication
(10) Pub. No.: US 2024/0412033 A1
(43) Pub. Date: Dec. 12, 2024

(54) ENGINE FOR RECONCILING NEURAL NETWORK MIGRATION

(71) Applicant: Bank of America Corporation, Charlotte, NC (US)

(72) Inventor: Saurabh Gupta, New Delhi (IN)

(21) Appl. No.: 18/208,411

(22) Filed: Jun. 12, 2023

(51) Int. Cl. G06N 3/04; H04L 9/40

(52) U.S. Cl. CPC G06N 3/04; H04L 63/0815

(57) ABSTRACT

A method for using a neural network to implement a cloud migration in response to receiving a request to provide the cloud migration for a predetermined application is provided. The method may include selecting a single cloud continuous integration continuation deployment (CICD) node from a plurality of continuous integration continuation deployment (CICD) nodes, selecting a single cloud configuration node from a plurality of cloud configuration nodes, selecting a single node selected from a plurality of cloud configuration nodes and selecting a single node selected from a plurality of single sign on nodes (SSO) and selecting a single application node from a plurality of application nodes. With one node from each of the groups able, the network may preferably initiate a migration process for the predetermined application.

### FIELD OF TECHNOLOGY

Aspects of the disclosure relate to neural networks.

### BACKGROUND OF THE DISCLOSURE

The technological world is moving towards a cloud-based platform but there is currently no direct mechanism available to do so. For the purposes of this application, the cloud should be understood to refer to a decentralized server network with larger computing capacity. The cloud is designed to communicate with numerous distributed computing devices and provide data and computing power to each of the numerous distributed computing devices.

If a legacy application is supposed to be migrated to a container or a cloud, then there may be more than fifty configuration steps which typically need to be performed manually. Such steps may take months of development time for each application.

Also, the configuration steps differ based on the different underlying platform that supports each application.

It would be desirable to put a technology in place which could enable an engine which could preferably pre-wire all the required configurations for cloud migration.

It would be even more desirable if such pre-wiring could occur irrespective of the underlying platform in a way that would reduce resources needed for cloud migration.

It would be yet further desirable to ease the effort of cloud migration, thus saving significant effort, resources and time.

### SUMMARY OF THE DISCLOSURE

A neural network for use with an implementation of a cloud migration is provided. The implementation of the cloud migration is preferably provided in response to receiving a request to provide the cloud migration for a predetermined application is provided.

The neural network may include a plurality of continuous integration continuation deployment (CICD) nodes; a plurality of cloud configuration nodes, each of the plurality of cloud configuration nodes coupled to each of the CICD nodes; a plurality of single sign on nodes (SSO), each of the SSO nodes coupled to the cloud configuration nodes and a plurality of application nodes coupled to each of the plurality of SSO nodes.

A single cloud configuration may be formed, according to certain embodiments, from a single node selected from the plurality of CICD nodes, a single node selected from the plurality of cloud configuration nodes, a single node selected from the plurality of SSO nodes, and a single node selected from the plurality of application nodes.

The neural network may also include a CICD pipeline integrator. The CICD pipeline integrator may test the migration in the pipeline and return a cloud migration compliance score based on the testing.

The cloud migration may be, in certain instances, determined to have more than a threshold cloud migration compliance score. In such instances, the neural network may be configured to rerun the implementation of the cloud migration.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative system in accordance with principles of the disclosure;

FIG. 3 shows a schematic diagram of a neural network in accordance with the principles of the disclosure;

FIG. 4 shows another schematic diagram of a neural network in accordance with principles of the disclosure; and

FIG. 5 shows a schematic flow diagram in accordance with principles of the disclosure.

### DETAILED DESCRIPTION OF THE DISCLOSURE

This disclosure is directed to an engine for reconciling neural network migration. This reconciling first initializes and then re-forms neural network node combinations of various different permutations. This engine preferably identifies and refines the best permutations of nodes from the network, in order for the application (in the alternative, “app”) to be migrated. If the migration does not comply with a pre-determined operational threshold, then the network learns from the operational gaps and reconnects to one or more suitable nodes from the network to the app for migration.

Each configuration node in the neural network preferably acts be an independent unit capable of performing the following integrations independently:
Prewired automatic integration with CICD environment to create product environments for Cloud.
Prewired automatic integration with GIT platform (GitHub, Inc., manufactured by Microsoft of Redmond, Washington, is an Internet hosting service for software development and version control using Git. It provides the distributed version control of Git plus access control, bug tracking, software feature requests, task management, continuous integration) for automatically creating API service within the code.
Integration with single sign on SSL SSO platform to enable seamless login experience.
Prewired integration with app dynamics environment to enable user to see app specific metrics post-cloud migration.
Prewired integration with logs platform to enable user to monitor logs post-cloud migration.
Automatic prewired integration with access platforms to enable respective teams to access cloud environments.
Enables platform independent migration irrespective of the underlying technology, database (DB), server, operating system (OS), etc.
Prewired with automated test framework to test the migration in the pipeline and show compliance score. In addition, other tests may be rerun in case of low compliance score.
Reduces migration time by up to 95%.

This technology may, in some embodiments, be broken into: Cloud Plugin Integrator, Requesting Platform Interpreter, Code Repo Integrator, CICD Pipeline Integrator, App Dynamics Interface (manufactured by Cisco Systems of California, to enable pre- and post-migration performance metrics), Log Platform Integrator, SSL SSO platform Interface, Env Access Provider, Platform Integration, Cipher Deploy Unit, Cipher Test Unit, and/or Cipher Variance Reporting Unit. Each of these components will be explained in more detail below.

Neural networks of adaptive and different cloud configuration nodes are provided. Each configuration node represents an exemplary constituent of the cloud platform to which the application will be migrated.

As such, the embodiments present a reconcilable, preferably self-adjustable neural network to enable optimal cloud configuration for the app. When the configuration proposed by this technology is not able to create a relatively high-performing cloud environment, then the embodiments may readjust the network and select another set of best available nodes from the network.

In addition, the embodiments set forth herein provide substantially seamless integration with 15-20 different platforms and enabling configuration nodes for seamless migration.

The conventional process is often highly-consumptive off manual effort, cost and complexity. This technology set forth herein saves a lot of time, effort and resources.

As described above, typical entities migrate their respective IT systems to the cloud. But each move to the cloud requires a custom-built new configuration.

For example, for .net applications a first cloud integration must be prepared. For java applications, a second, different, cloud integration must be prepared. And even within java—for a java application involving Spring™ a specific cloud integration must be prepared, and for a java application involving Hibernate™ a different integration must be prepared. Certain integrations that involve a database require a first configuration while others that do not involve a database may require a different configuration.

As such, if an entity uses 1,000 applications and wants to integrate 10% of the applications to cloud—this requires a major entity effort. Specifically, this may require the manual creation of 100 different cloud configurations. In fact, in one known instance, it took three full-time employees working for six (6) months to complete a single integration.

Each manual creation of a cloud configuration may take months to integrate with the cloud. Because each application has a technology stack, each aspect of the technology stack currently requires manual intervention to convert to the cloud.

It would be desirable to provide AI that utilizes a continually improving library of integrations to help prepare integrations in the future.

The foregoing reconciling neural network containers related to cloud integration according to the disclosure include the following aspects.

The following figures and associated written specifications set forth the invention in additional detail to the foregoing.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

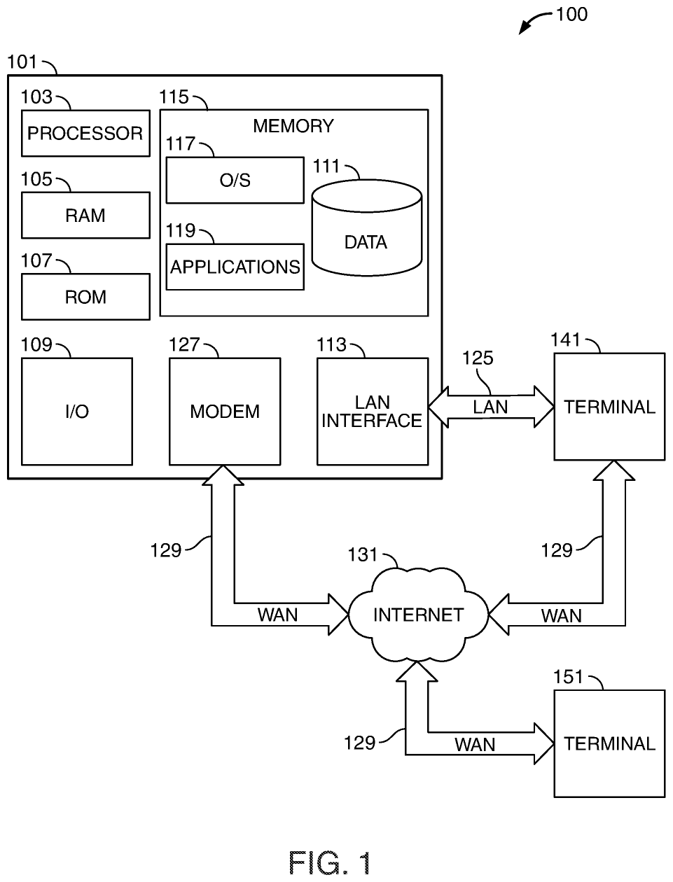

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

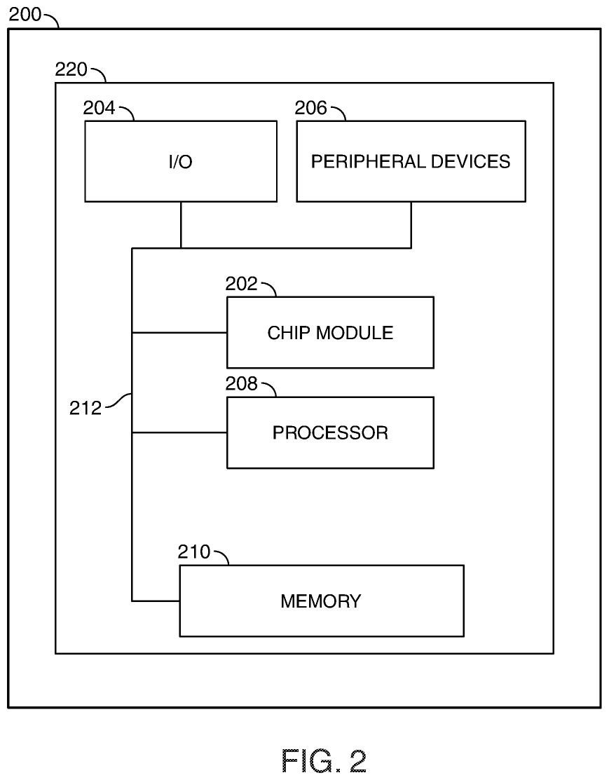

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

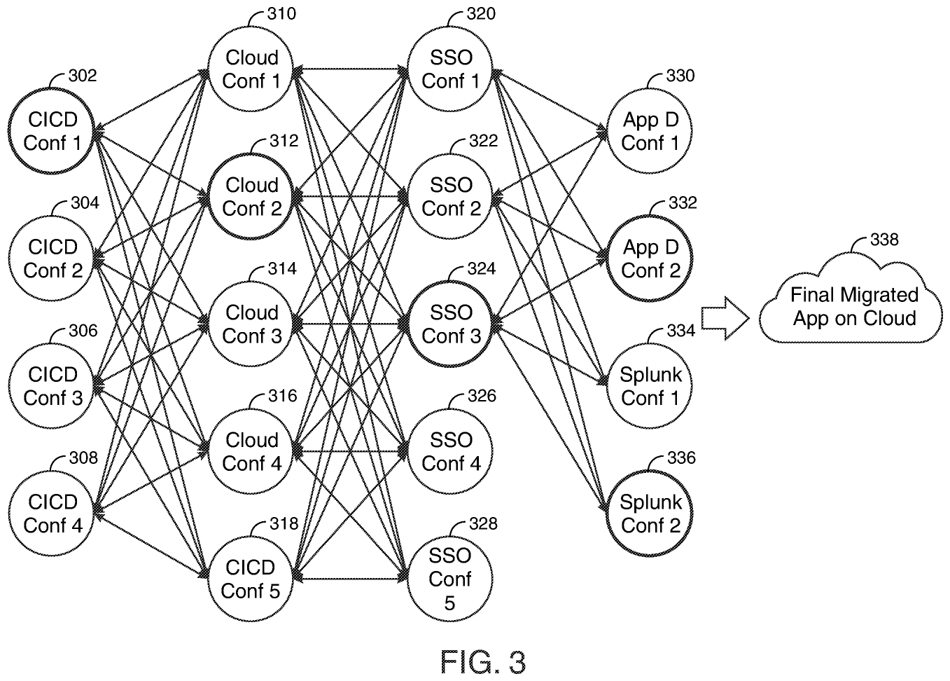

FIG. 3 shows a schematic version of a neural network for providing various configurations of nodes for cloud integrations. The schematic representations shown in FIG. 3 are preferably sufficiently intelligent to replicate themselves as needed or to form one or more new nodes customized to provide a novel configuration. The novel configuration may preferably be based upon one or more newly learned aspects of the configuration.

As such, the neural network may preferably be able to provide an initial configuration for cloud migration absent user input. In certain embodiments, this engine suggests all the configurations that may be used to respond to a request for an application to migrate to the cloud. At the final stage, following the pre-wiring process of preparing an initial cloud configuration for the requested application, the application may preferably be fully cloud implementable absent the application owner's adding any manually-prepared code.

Thereafter, whenever the neural network determines that the selected cloud configuration is operating sub-optimally—e.g., some of the connections suggested by the initial configuration were not working—the neural network may reconcile what may be considered a convoluted neural network. For example, the neural network may preferably re-run a selection process in order to obtain a higher performance cloud configuration. In these cases, the neural network may preferably revisit the previous configurations that were suggested. At this point the neural network may provide a better performing neural network based upon the understanding of the sub-optimalities that currently exist in the network as well as the legacy information stored in the database.

So, in short, the application receives a request for a cloud configuration, pre-wires a cloud configuration to meet the needs of the application being configured, and reconciles the neural network as needed to perform, test the operation of the suggested configuration, and maintain and improve the performance, of the cloud configuration into the future.

FIG. 3 shows a list of continuation integration continuous deployment (CICD) engines 302, 304, 306, 308, a list of cloud configurations (confs) 310, 312, 314, 316, and 318, a list of Single Sign On (SSOs) configurations 320, 322, 324, 326, 328 and a list of applications 330, 332 and splunk configuration (conf) 1 334 and splunk conf 2 336. Furthermore, each of the CICDs, clouds, SSOs and applications are broken down between configuration (conf) 1, conf 2, conf 3, conf 4 and conf 5.

As shown in FIG. 3, the initial selection of nodes (shown with a bold outline) involved CICD conf 1 302, cloud conf 2 312, SSO conf 3 324 and app d conf 2 332. At 338—the final migrated app for supporting the cloud configuration is shown.

For the purposes of this application CICD should be understood to refer to continuous integration and continuous delivery/continuous deployment. CI is a modern software development practice in which incremental code changes are made frequently and reliably. Automated build-and-test steps triggered by CI ensure that code changes being merged into a repository are reliable. The code is then delivered relatively quickly and preferably seamlessly as a part of the CD process. In the software world, the CI/CD pipeline refers to the automation that enables incremental code changes from developers' desktops to be delivered quickly and reliably to production. In the context of the current application, this refers to changes that affect neural network directed to migration to a cloud or other similar system.

For the purposes of this application, the cloud config nodes may be understood to provide server and client-side support for externalized configuration in a cloud system. The cloud config nodes may be implemented to manage external properties for applications across all environments. These nodes can be used with preferably any application running in preferably any relevant language. As an application moves through the deployment pipeline from development to testing and into production and finally to cloud, these nodes can manage the configuration between those environments and preferably ensure that applications have everything they need to run when they migrate. The default implementation of the server storage backend uses git so it easily supports labelled versions of configuration environments, as well as being accessible to a wide range of tooling for managing the content.

For the purposes of this application, Splunk configuration files (or “conf files”) using the .conf file extension—should be understood to refer to a series of files that dictate almost all settings in a Splunk environment. This includes data inputs, outputs, data modification, indexes, clustering, performance tweaks, and much more. Splunk deployments can have several conf files of the same name in various directories, and “merge” same via precedence rules. As such, these, or similar type files, can be invaluable to enabling an application to be migrated to a cloud environment.

Different conf files exist in a global context and an app/user context, the latter of which typically are used for search related activities.

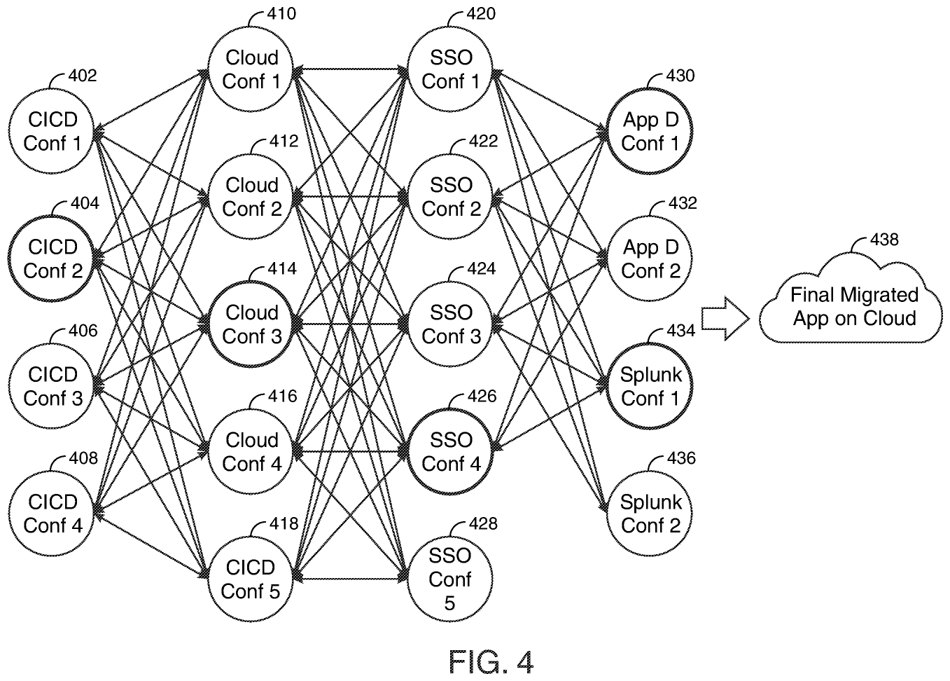

FIG. 4 shows a reconciled group of nodes, following a reconciliation of the previously ordered nodes. Specifically, FIG. 4 shows, in bold, nodes CICD conf 2, 404, cloud conf 3 414, SSO conf 4 426 and splunk conf 1 434. It should be noted that the reconciliation was preferably based on information received regarding sub-optimal operation of the initial selection, shown in FIG. 3, and the previously stored information in the neural network. It should be noted that, even in FIG. 4, the selection of the nodes of the neural network were preferably selected from the same choices of neural networks as were available at the initiation of the configuration—i.e., a list of CICDs 402, 404, 406, 408, a list of clouds 410, 412, 414, 416, and 418, a list of Single Sign On (SSOs) configurations 420, 422, 424, 426, 428 and a list of applications (app d) 430, 432 and splunk conf 1 434 and splunk conf 2 436. At 438—the final migrated app for supporting the cloud configuration is shown.

For example, at some point the system took note that the neural network was having difficulty processing high network traffic from a particular node or region (a collection of nodes) during a particular time period. The network may, at that point, suggest a second configuration with a historically-confirmed increased ability to handle network traffic from the affected nodes during the designated time period. It should be noted that such a suggested roll-out may be taken as a learning for future initially suggested offerings for the neural network and/or reconciliations of neural networks. Such a system may preferably allow the neural network to limit repetition of sub-optimal initially suggested configurations.

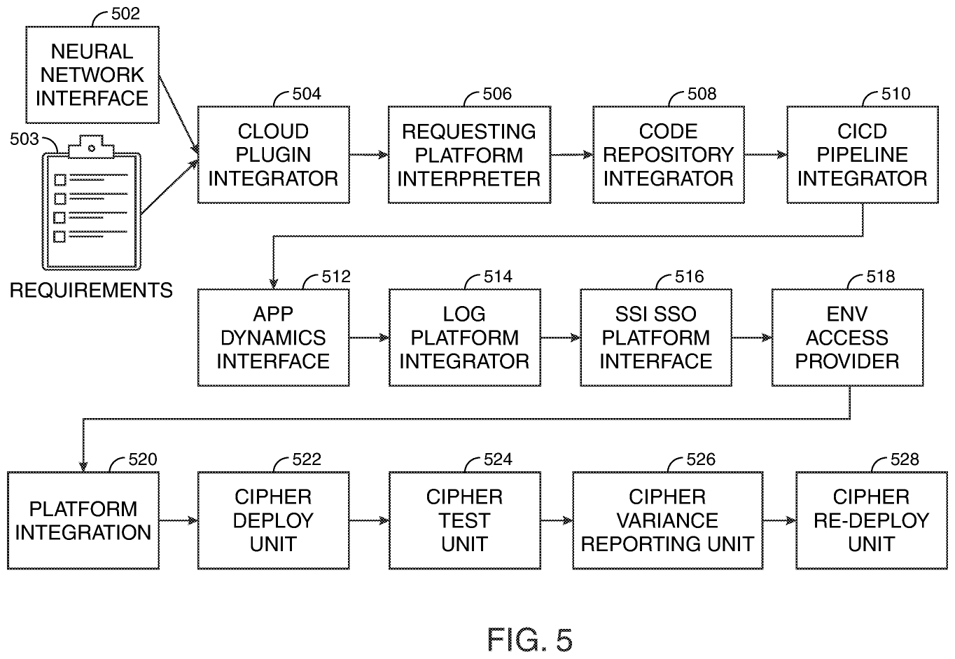

In FIG. 5, a neural network interface is shown at 502. Interface 502 serves to provide an initial communication façade for communicating with the neural network and system according to the disclosure.

Cloud plugin integrator 504 shows the integration point between system requirements 503 of the application and the cloud integration as set forth in the neural network interface 502. Cloud plugin integrator 504 preferably deciphers details for integration into the cloud.

At 506, a requesting platform interpreter is shown. This interpreter 506 schematically shows a system for determining which application or platform is being migrated. As such, this interpreter 506 can preferably integrate with any underlying app based on a determination of which underlying technology stacks are being requested to be migrated.

At 508, a code repository integrator is shown. Code repository integrator 508 engine can take the code in which the application being migrated is written and integrate the code for use with the cloud migration—i.e., rewrite the code as necessary to integrate the code into the cloud migration. Based upon the integrated code, better configurations, at CICD pipeline integrator 510, can be suggested and/or implemented.

It should be noted that the code can be sitting in preferably any repository. Further, integrator 508 is capable of platform independent integration and, together with CICD pipeline integrator 510, can provide code implementation for the cloud environment. Integrator 508 and CICD may analyze the deployment technology and create a duplicate of the current deployment technology for use with the cloud configuration.

Apps dynamic interface 518 may include information about the application. For example, apps dynamic interface 518 may preferably show how much memory an app is using, what is the performance of the app, how many network calls are getting fired, what is the load time of the application, etc. Apps dynamic interface 518 may preferably create a similar replica for use with the application once the cloud migration has been integrated.

Log platform integrator 514 may, similar to apps dynamic interface 518, may preferably create a log platform for use with the application once the application has been integrated into the cloud. As above, log platform integrator may preferably 514 replicate the current logging mechanism as a similar log platform in the cloud environment.

It is important to note that the neural network engine according to the disclosure operates at a high level to understand the code of the application or platform being migrated, understand the requirements of the application or platform being migrated and reproduce such code and requirements for use with the cloud version of the application or platform, building an application statistics monitoring mechanism for the application or platform being migrated, for use with the cloud version of the application or platform being migrated, enabling a login mechanism for the application or platform being migrated, for use with the cloud version of the application or platform being migrated, building an SSI SSO platform interface 516 for the application or platform being migrated, for providing an SSI SSO library for use with the cloud version of the application or platform being migrated, building an environment access mechanism for the application or platform being migrated, for use with the cloud version of the application or platform being migrated, as well as performing overall platform integration 520 as set forth herein, deploying same at the cipher deploy unit 522, and testing the final cloud migrated product at cipher test unit 524 as well.

It should be noted that the variance derived from the cipher test unit 524 with respect to the original expected results may be reported by the cipher variance reporting unit 526 and then used for future re-deployment by cipher re-deployment unit 528.

From the foregoing it is apparent that neural networks for supporting various cloud configurations have been provided. Each configuration represents the cloud platform which obtains implementation for the migration to the cloud of an application. Reconcilable, self-adjustable neural networks according to the disclosure enable cloud configuration for the app. When the proposed configuration is not able to create an optimal cloud environment, then the disclosed embodiments preferably readjust the neural network and select another set of best available nodes from the network.

As such, an auto-enabled cloud migration with preferably zero manual intervention is provided. Such seamless integration may work with many different platforms. The current disclosure preferably substantially eliminates manual effort, cost and complexity.

Thus, methods and apparatus provide engines for reconciling neural network migration. Persons skilled in the art will appreciate that the present invention can be practiced by other than the described embodiments, which are presented for purposes of illustration rather than of limitation, and that the present invention is limited only by the claims that follow.

What is claimed is:

1. A neural network for use with implementing a cloud migration in response to a receiving a request to provide the cloud migration for a predetermined application, the neural network comprising:
a plurality of continuous integration continuation deployment (CICD) nodes;
a plurality of cloud configuration nodes, each of the plurality of cloud configuration nodes couples to each of the CICD nodes;
a plurality of single sign on nodes (SSO), each of the SSO nodes coupled to the cloud configuration nodes; and
a plurality of application nodes coupled to each of the plurality of SSO nodes;
wherein a single cloud configuration is formed from a single node selected from the plurality of CICD nodes, a single node selected from the plurality of cloud configuration nodes, a single node selected from the plurality of SSO nodes, and a single node selected from the plurality of application nodes.

2. The neural network of claim 1 further comprising a CICD pipeline integrator, said CICD pipeline integrator that tests the migration in the pipeline and returns a cloud migration compliance score based on the testing.

3. The neural network of claim 1 wherein, wherein the cloud migration is determined to have more than a threshold cloud migration compliance score, rerun the implementation of the cloud migration.

4. The neural network of claim 1 further comprising a neural network interface for interfacing between the request and the neural network.

5. The neural network of claim 4 further comprising a cloud plugin integrator for providing an integration point between a plurality of application requirements of the application and the cloud migration as defined in the neural network interface.

6. The neural network of claim 1 further comprising a platform interpreter for determining an identity of the application being migrated.

7. The neural network of claim 1 further comprising a code repository, said code repository coupled to the neural network, said code repository for rewriting the code in which the application is written and integrating the code for use with the cloud migration.

8. The neural network of claim 1 further comprising an application dynamics interface, the application dynamics interface that posts a plurality of user app specific metrics post cloud migration.

9. The neural network of claim 1 further comprising an SSI single sign on (SSO) platform interface, said SSO platform interface for providing an SSO library for use with the cloud migration.

10. A method for using a neural network to implement a cloud migration in response to receiving a request to provide the cloud migration for a predetermined application, the method comprising:
selecting a single cloud continuous integration continuation deployment (CICD) node from a plurality of continuous integration continuation deployment (CICD) nodes;
selecting a single cloud configuration node from a plurality of cloud configuration nodes;
selecting a single node selected from a plurality of cloud configuration nodes; and
selecting a single node selected from a plurality of single sign on nodes (SSO); and
selecting a single application node from a plurality of application nodes.

11. The method of claim 10 further comprising using a CICD pipeline integrator to test the migration in the pipeline and return a cloud migration compliance score based on the testing.

12. The method of claim 10 wherein, wherein the cloud migration is determined to have more than a threshold cloud migration compliance score, rerun the implementation of the cloud migration.

13. The method of claim 10 further comprising using a neural network interface to interface between the request and the neural network.

14. The method of claim 13 further comprising using a cloud plugin integrator to provide an integration point between a plurality of application requirements of the application and the cloud migration as defined in the neural network interface.

15. The method of claim 10 further comprising using a platform interpreter to determine an identity of the application being migrated.

16. The method of claim 10 further comprising coupling a code repository to the neural network, and using said code repository to rewrite the code in which the application is written and to integrate the code for use with the cloud migration.

17. The method of claim 10 further comprising using an application dynamics interface to provide a plurality of user app specific metrics post cloud migration.

18. The method of claim 10 further comprising using a single sign on (SSO) platform interface to provide an SSO library for use with the neural network.

19. A method for using a neural network to implement a cloud migration in response to receiving a request to provide the cloud migration for a predetermined application, the method comprising:
selecting a single cloud continuous integration continuation deployment (CICD) node from a plurality of CICD nodes;
selecting a single cloud configuration node from a plurality of cloud configuration nodes; and
selecting a single sign on (SSO) node selected from a plurality of SSO nodes; and
selecting a single application node from a plurality of application nodes, wherein said selected CICD node, said selected cloud configuration node, said selected SSO node, and said selected single application node form the neural network for initiating cloud migration for the predetermined application.
